(19) United States
(12) Patent Application Publication
(10) Pub. No.: US 2023/0359842 A1
(43) Pub. Date: Nov. 9, 2023

(54) READER/WRITER DEVICE AND STAND FOR READER/WRITER

(71) Applicant: Sony Group Corporation, Tokyo (JP)

(72) Inventors: Mitsuru HARADA, Kanagawa (JP); Tomotsugu MINAMIKAWA, Tokyo (JP)

(73) Assignee: Sony Group Corporation, Tokyo (JP)

(21) Appl. No.: 18/022,860

(22) PCT Filed: Jul. 14, 2021
(86) PCT No.: PCT/JP2021/026437

§ 371 Date: Feb. 23, 2023

(30) Foreign Application Priority Data
Sep. 9, 2020 (JP) 2020-151463

(51) Int. Cl. G06K 7/10

(52) U.S. Cl. CPC G06K 7/109

(57) ABSTRACT

There is provided a reader/writer device that holds an IC card in a state where the IC card is held over a card reading surface during a communication period and supports a reader/writer main body in a posture separated from a setting surface. The reader/writer device includes a reader/writer main body that communicates with an IC card placed on a card reading surface, and a stand that supports the reader/writer main body in a posture separated from a setting surface and holds the IC card on the card reading surface. The stand has a structure having a substantially U shape and bundles and holds the IC card placed on the card reading surface and the reader/writer main body.

### TECHNICAL FIELD

The technology disclosed in the present specification (hereinafter referred to as “the present disclosure”) relates to a reader/writer device that communicates with an IC card placed on a card reading surface and a stand for a reader/writer.

### BACKGROUND ART

In recent years, radio frequency identification (RFID) systems that perform authentication and data communication by non-contact communication have been widely spread. The RFID system includes an RF tag and a reader/writer that reads and writes data from and in the RF tag. Communication between the reader/writer and the RF tag is performed by a magnetic field emitted from the reader/writer. Near Field Communication (NFC), which is one technical system of the RFID system, is a short-range wireless communication technology that uses a frequency of 13.56 MHz and has a communication distance of about 10 centimeters. In Japan, NFC is widely used for electronic payment, personal authentication, and the like. Note that “non-contact” of the non-contact communication means an electrical non-contact state, and a state in which the surfaces of the RF tag and the reader/writer are in contact with each other is also referred to as “non-contact”.

There are various forms of the reader/writer and the RF tag. The reader/writer is incorporated in an information terminal such as a personal computer (PC) or a smartphone, and a device such as a ticket gate in some cases, and is externally connected to a device such as a PC by using a cable such as a universal serial bus (USB) cable in the cases. Furthermore, the RF tag is included as an integrated circuit (IC) tag in an information terminal such as a smartphone in some cases, and is an IC card having approximately the same size as a business card in other cases. For example, a reader/writer used by being connected to a portable processing terminal such as a personal computer by using a wired cable has been proposed (see Patent Document 1).

The present disclosure mainly deals with a reader/writer device of a type that is externally connected to a device such as a PC by using a cable such as a USB cable and performs read/write operation on an IC card. The IC card is widely used as an authentication card such as an entrance card or an employee ID card. Furthermore, in Japan, it is expected that the reader/writer device externally connected to an information terminal such as a PC will become more popular due to issuance of an Individual Number Card with an IC chip and expansion of applications of the Individual Number Card such as use of the Individual Number Card as a health insurance card.

Non-contact communication between the reader/writer device and the IC card is performed by a magnetic field emitted from the reader/writer when the IC card is held over a card reading surface of the reader/writer device. In a case where the IC card is used for login, it is necessary to hold the IC card over the card reading surface of the reader/writer device during a communication period. Furthermore, the reader/writer device of a type externally connected to an information terminal such as a PC is assumed to be placed on various objects such as a desk, a table, or a work table and used. In a case where the reader/writer device is placed on a desk including metal and used, there is a concern that an eddy current is generated in the metal by the magnetic field emitted from the reader/writer device and adversely affects communication between the reader/writer device and the IC card.

### CITATION LIST

### Patent Document

Patent Document 1: Japanese Patent Application Laid-Open No. 2019-133238

### SUMMARY OF THE INVENTION

### Problems to be Solved by the Invention

An object of the present disclosure is to provide a reader/writer device that is connected to an information terminal by using a cable and communicates with an IC card placed on a card reading surface and a stand for a

### Solution to Problems

The present disclosure has been made in view of the problems described above, and a first aspect thereof is
a reader/writer device including:
a reader/writer main body that communicates with an IC card placed on a card reading surface; and
a stand that supports the reader/writer main body in a posture separated from a setting surface and holds the IC card on the card reading surface.

The stand is a structural body including a side wall portion on a back side of the U shape, a bottom plate portion connected to a lower end of the side wall portion, and a top plate portion connected to an upper end of the side wall portion, and bundles and holds the IC card placed on the card reading surface and the reader/writer main body. Furthermore, the side wall portion has an opening through which a cable for connecting the reader/writer main body to an external device is inserted.

The top plate portion includes a card holding portion that protrudes inside the U shape and abuts on an upper surface of an IC card placed on the reader/writer main body. Furthermore, the top plate portion includes a card locking portion that locks a leading edge of the IC card and positions the IC card on the card reading surface.

The bottom plate portion includes a fixing portion that fixes the reader/writer main body. The fixing portion includes a linear protrusion engaged with a linear groove formed in a bottom surface of the reader/writer main body.

Furthermore, a second aspect of the present disclosure is a stand for a reader/writer including:
a support portion that supports a reader/writer main body in a posture separated from a setting surface; and
a holding portion that holds an IC card placed on a card reading surface of the reader/writer main body.

### Effects of the Invention

According to the present disclosure, it is possible to provide a reader/writer device and a stand for a reader/writer capable of holding an IC card in a state where the IC card is held over a card reading surface during a communication period and supporting a reader/writer main body in a posture separated from a setting surface.

Note that the effects described in the present Description are merely examples, and the effects brought by the present disclosure are not limited thereto. Furthermore, the present disclosure further provides additional effects in addition to the effects described above in some cases.

Still other objects, features, and advantages of the present disclosure will become apparent from a more detailed description based on embodiments to be described later and the accompanying drawings.

### BRIEF DESCRIPTION OF DRAWINGS

FIG. 1 is a view illustrating an external configuration of a reader/writer device 100.

FIG. 2 is a view illustrating an external configuration of a reader/writer main body 110.

FIG. 3 is a view illustrating an exploded view of the reader/writer device 100.

FIG. 4 is a view illustrating a state in which a USB cable as connected to a base side of a substrate 303.

FIG. 5 is a view illustrating a state in which a USB connector 401 on the USB cable 400 side is inserted into the reader/writer main body 110.

FIG. 6 is a view illustrating a state in which the USB connector 401 on the USB cable 400 side is inserted into the reader/writer main body 110.

FIG. 7 is a view illustrating a cross section of the reader/writer main body 110 to which the USB connector 401 is inserted.

FIG. 8 as a view illustrating a cross section of the reader/writer device 100 to which the USB connector 401 is inserted.

FIG. 9 is a view illustrating a state in which a stand 120 is fitted to the reader/writer main body 110 on which an IC card 901 is placed.

FIG. 10 is a view illustrating an external configuration of the stand 120.

FIG. 11 is a view illustrating the external configuration of the stand 120.

FIG. 12 is a view illustrating the external configuration of the stand 120.

FIG. 13 is a view illustrating a cross-sectional configuration of the stand 120.

FIG. 14 is a view illustrating a bottom surface of the reader/writer main body 110.

FIG. 15 is a view illustrating a state in which the reader/writer device 100 (that is, the reader/writer main body 110 with the stand 120 fitted to the reader/writer main body 110) is put on a horizontal setting surface.

FIG. 16 is a view illustrating a state in which the reader/writer main body 110 is directly put on a horizontal setting surface.

FIG. 17 is a view illustrating a state in which the USB cable 400 is stored by using the stand 120.

FIG. 18 is a view illustrating a state in which the USB cable stored in the stand is put in a carrying bag.

FIG. 19 is a diagram illustrating an internal configuration example of the reader/writer main body 110.

FIG. 20 is a view illustrating a method of fixing a reader/writer device and an IC card.

FIG. 21 is a view illustrating a method of leaning a reader/writer device by using a stand.

### MODE FOR CARRYING OUT THE INVENTION

Hereinafter, the present disclosure will be described in the following order with reference to the drawings.
A. Overview
B. Configuration of Reader/Writer Device
C. Functions of Stand
C-1. Function of Fixing IC Card
C-2. Structure of Stand
C-3. Function of Supporting IC Card
C-4. Structure of Mounting Cable
C-5. Function of Storing Cable
D. Internal Configuration of Reader/Writer Main Body
E. Effects

A. Overview

The present disclosure relates to a reader/writer device that is connected to an information terminal by using a cable and communicates with an IC card placed on a card reading surface.

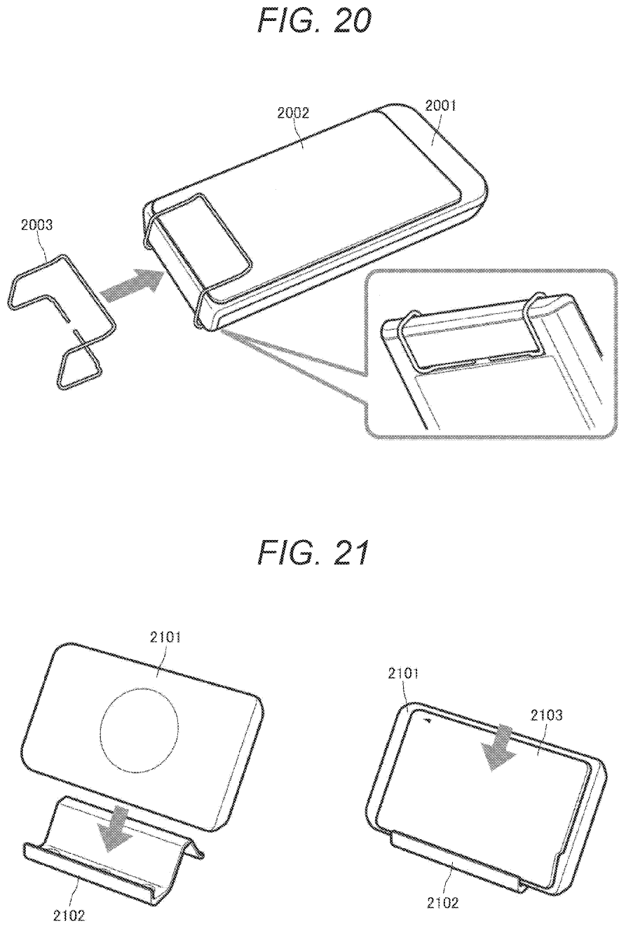

The reader/writer device can originally perform communication without bringing the IC card into contact with the reader/writer device. However, in a case where the IC card is used for login, it is necessary to keep holding the IC card over the card reading surface of the reader/writer device during a communication period. During login, if the user keeps holding the IC card in the hand and holding the IC card over the card reading surface of the reader/writer device, the user cannot perform other work. Therefore, as illustrated in FIG. 20, a method has been considered in which a reader/writer device 2001 and an IC card 2002 placed on a card reading surface are fastened with a clip (hereinafter, also referred to as a “card holder”) 2003 including a flexible wire or the like, and the IC card is fixed at a communicable position during login. Since the card holder 2003 includes metal, the card holder 2003 has design constraints.

Furthermore, the reader/writer device of a type externally connected to an information terminal such as a PC is assumed to be placed on various objects such as a desk, a table, or a work table and used. In a case where the reader/writer device is placed on a desk including metal and used, there is a concern that an eddy current is generated in the metal by the magnetic field emitted from the reader/writer device and adversely affects communication between the reader/writer device and the IC card. Therefore, as illustrated in FIG. 21, a method has been considered in which a reader/writer device 2101 is leaned by using a stand 2102 instead of being placed flat and is separated from the setting surface to prevent generation of an eddy current. In this case, the IC card 2103 needs to be leaned together with the reader/writer device 2101 in a state where the IC card 2103 is in contact with the card reading surface.

In a posture in which the reader/writer device 2101 is placed on the stand 2102 and leaned obliquely instead of being placed flat, the position of the IC card 2103 is more easily displaced. Therefore, the card holder 2003 illustrated in FIG. 20 needs to be used in combination with the stand 2102. Furthermore, since a location where a cable (not illustrated in FIG. 21) for connection to an information terminal is inserted into the reader/writer device 2101 is determined, it is necessary to devise a way of placing the reader/writer device 2101 in order to make the reader/writer device 2101 is leaned against the stand 2102 while being turned sideways as illustrated in FIG. 21.

Although not illustrated in FIGS. 20 and 21, the cable for connection to the information terminal has a length of about 1 meter, is difficult to handle when not in use, and is inconvenient to carry.

Therefore, the present disclosure proposes a reader/writer device including a reader/writer main body and a stand that supports the reader/writer main body in a posture separated from a setting surface. In the present disclosure, the stand also has a function of fixing an IC card on a card reading surface of the reader/writer main body. Therefore, as illustrated in FIGS. 20 and 21, it is not necessary to use two accessory parts, that is, the card holder 2003 and the stand 2102.

Furthermore, although details will be described later, the stand according to the present disclosure has a structure that supports the reader/writer main body at a location where a cable is inserted into the reader/writer main body, so that the reader/writer main body can be easily leaned in a state where the cable is pierced. Furthermore, the stand according to the present disclosure also has a function of storing the cable that is not used when the stand is detached from the reader/writer main body.

B. Configuration of Reader/Writer Device

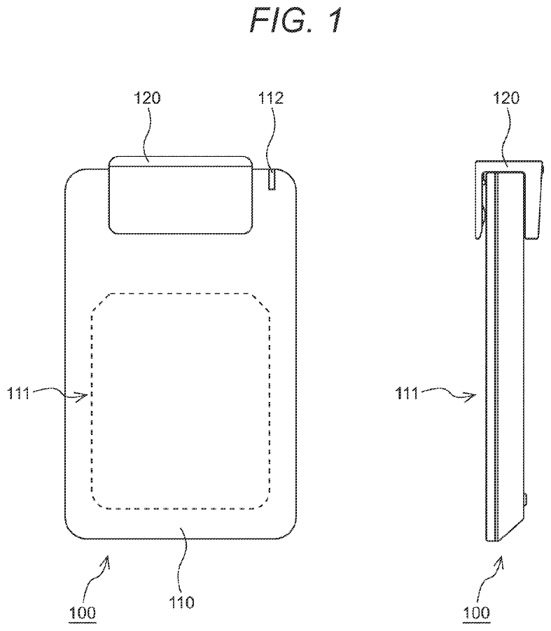

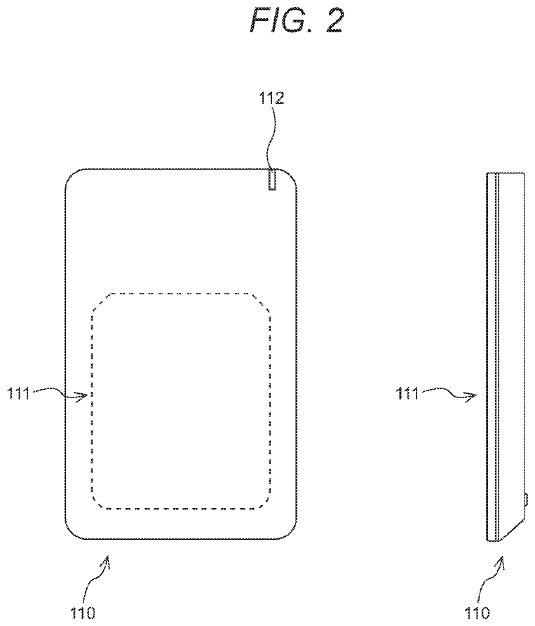

FIG. 1 illustrates an external configuration example of a reader/writer device 100 according to the present disclosure. The reader/writer device 100 includes a reader/writer main body 110 and a stand 120. FIG. 1 illustrates a top view (left in FIG. 1) of the reader/writer device 100 as viewed from the card reading surface 111 side of the reader/writer main body 110, and a side view (right in FIG. 1) of the reader/writer device 100 as viewed from the right side. Furthermore, for reference, FIG. 2 illustrates a top view and a side view of only the reader/writer main body 110.

FIG. 1 illustrates a state in which the stand 120 is fitted to one edge of the reader/writer main body 110 having a rectangular shape. The stand 120 can be freely attached to and removed from the reader/writer main body 110, but a mounting location of the stand 120 is basically as illustrated in FIG. 1. In the present Description, or the two short sides facing each other of the reader/writer main body 110, the side to and from which the stand 120 is attached and removed is defined as a base side, and the opposite side is defined as a front end side. Therefore, the stand 120 is attached to and removed from the base side of the reader/writer main body 110 in the long side direction of the reader/writer main body 110.

The reader/writer main body 110 is slightly larger than the business card-size IC card, and has a size of, for example, about 100 mm×60 mm×10 mm. The reader/writer main body 110 can perform short-range wireless communication or non-contact communication based on, for example, the NFC method with the IC card (not illustrated in FIG. 1) placed on a card reading surface 111 (or held over the card reading surface).

Furthermore, the reader/writer main body 110 includes a state display unit 112 including a light emitting diode (LED) or the like at an edge on the base side. The state display unit 112 displays an operation state of the reader/writer main body 110 such as a state of communication with the IC card by flashing of emitted light, light emission color, or the like. The stand 120 can be freely attached to and removed from the base side of the reader/writer main body 110, and the state display unit 112 is arranged in a place that is not hidden by the stand 120 even in a state where the stand 120 is attached.

The stand 120 has both a function of supporting the reader/writer main body 110 in a posture separated from the setting surface of a desk or the like and a function of fixing the IC card (not illustrated in FIG. 1) on the card reading surface 111 of the reader/writer main body 110. The stand 120 can be freely attached to and removed from the base side of the reader/writer main body 110. As can be seen with reference to the side view on the right in FIG. 1, the stand 120 has a substantially U shape, and the reader/writer main body 110 can be fitted and removed through an opening having the U shape. The stand 120 is fitted to the reader/writer main body 110 such that the base side of the reader/writer main body 110 is sandwiched inside the U shape.

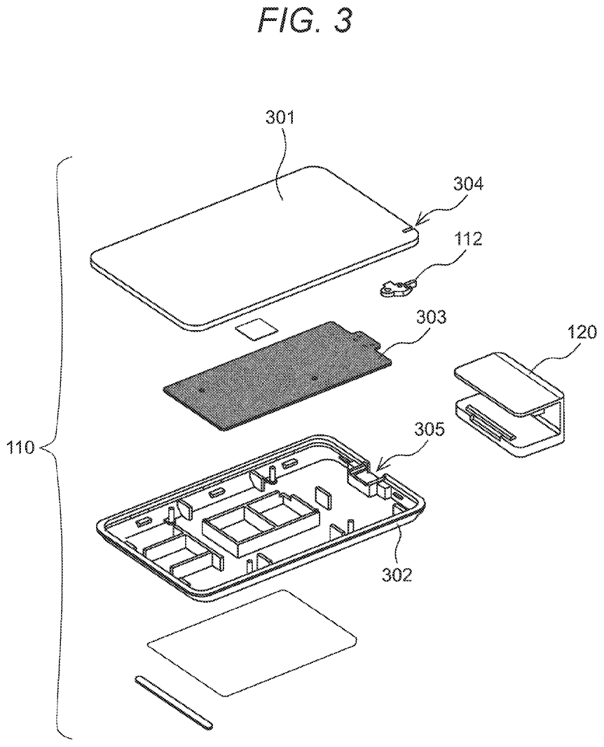

FIG. 3 illustrates an exploded view of the reader/writer device 100. The reader/writer device 100 includes the reader/writer main body 110 and the stand 120, and the stand 120 can be freely fitted and removed in the long side direction of the reader/writer main body 110 on the base side of the reader/writer main body 110 (described above).

The reader/writer main body 110 is disassembled into a housing including an upper casing 301 and a lower casing 302, and a substrate 303 incorporated in the housing so as to be sandwiched between the upper casing 301 and the lower casing 302. Furthermore, the state display unit 112 including an LED or the like is also incorporated in the housing. Then, on the base side of the upper casing 301, a cutout portion 304 for exposing the state display unit 112 to the outside is formed.

Although circuit components such as a communication module, a loop antenna, and other wirings are mounted on the substrate 303, these are not illustrated in FIG. 3 for the sake of simplicity. Basically, it is assumed that the communication module and the driving circuit component of the state display unit 112 are arranged on the base side of the substrate 303, and the loop antenna is arranged on the front end side of the substrate 303.

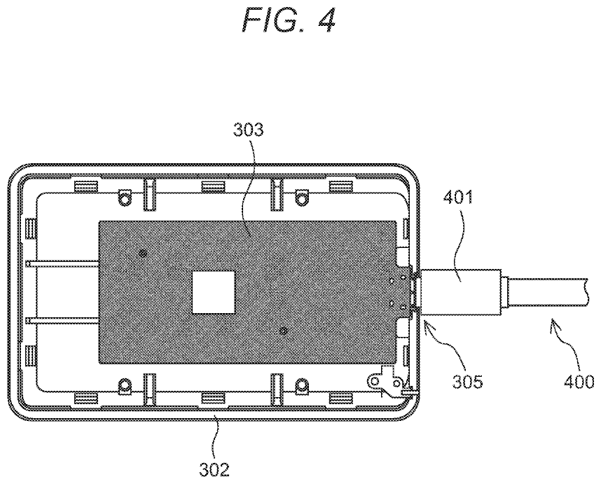

Furthermore, a USB connector into which a USB connector on the USB cable side is inserted is disposed on the base side of the substrate 303. For reference, FIG. 4 illustrates a state in which a USB connector 401 on the USB cable 400 side is inserted into the base side of the substrate 303. As can be seen from FIG. 3, an opening portion 305 into which the USB connector on the USB cable side is inserted is formed on the base side of the lower casing 302.

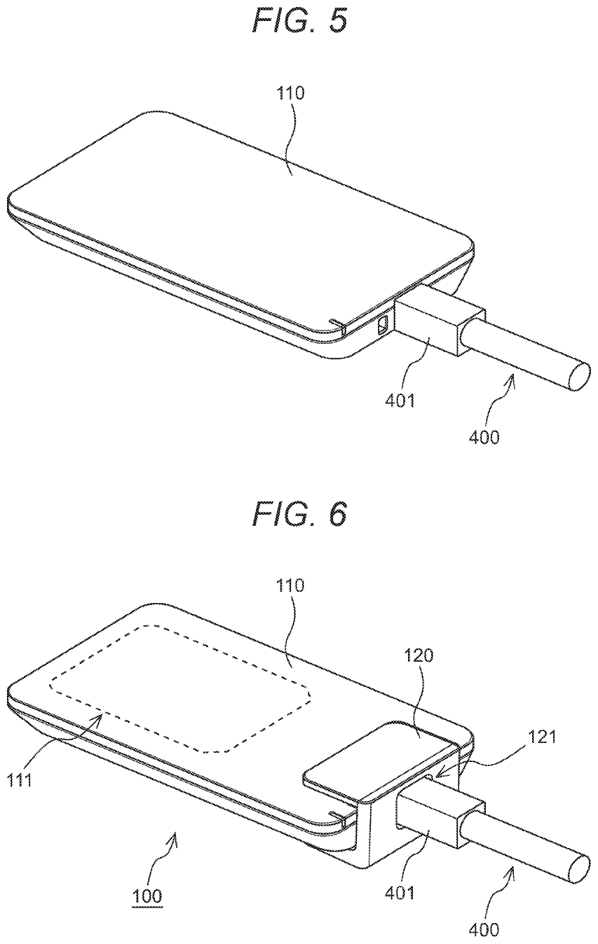

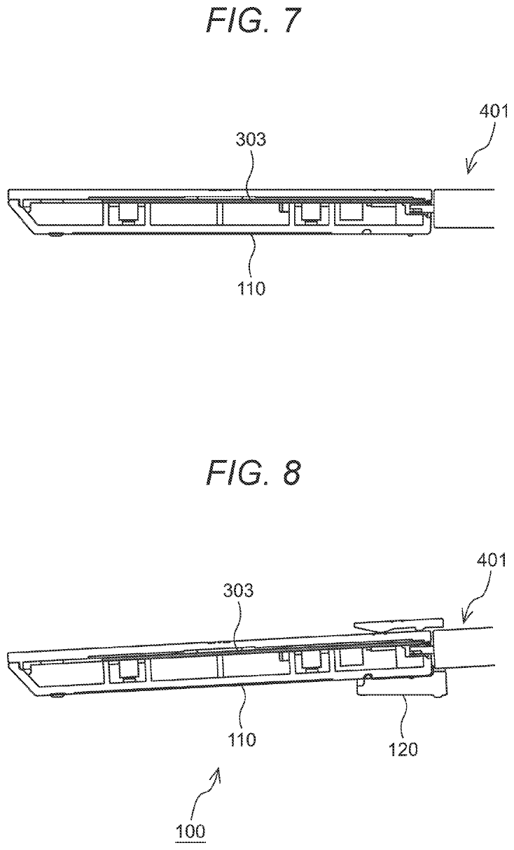

FIG. 5 is a view illustrating a state in which the USB connector 401 on the USB cable 400 side is inserted into the base side of the reader/writer main body 110. Furthermore, FIG. 6 illustrates a state in which the USB connector 401 on the USB cable 400 side is inserted into the reader/writer main body 110 with the stand 120 fitted to the base side thereof. The USB connector insertion port 305 of the reader/writer main body 110 is on the base side and overlaps with the location where the stand 120 is fitted. Therefore, an opening 121 through which the USB connector 401 on the USB cable 400 side passes is formed in a wall surface on the back side of the U shape of the stand 120. As can be seen from FIG. 6, the USB connector 401 is inserted into the USB connector insertion port 305 provided on the base side of the reader/writer main body 110 through the opening 121 of the stand 120. For reference, FIG. 7 illustrates a cross section of the reader/writer main body 110 into which the USB connector 401 is inserted. Furthermore, FIG. 8 illustrates a cross section of the reader/writer device 100 into which the USB connector 401 is inserted (in a state where the stand 120 is fitted to the reader/writer main body 110.

As can be seen from FIGS. 6 and 8, since the USB connector 401 is inserted into the USB connector insertion port 305 provided on the base side of the reader/writer main body 110 through the opening 121 of the stand 120, the USB connector 401 can be attached and removed with the stand 120 mounted to the reader/writer main body 110.

C. Functions of Stand

In this section, the structure and functions of the stand 120 will be mainly described in detail.

C-1. Function of Fixing IC Card

The stand 120 has a function of supporting the reader/writer main body 110 in a predetermined posture when the reader/writer device 100 is set on a work surface of a desk or the like, and further has a function of fixing the IC card on the card reading surface 111 of the reader/writer main body 110.

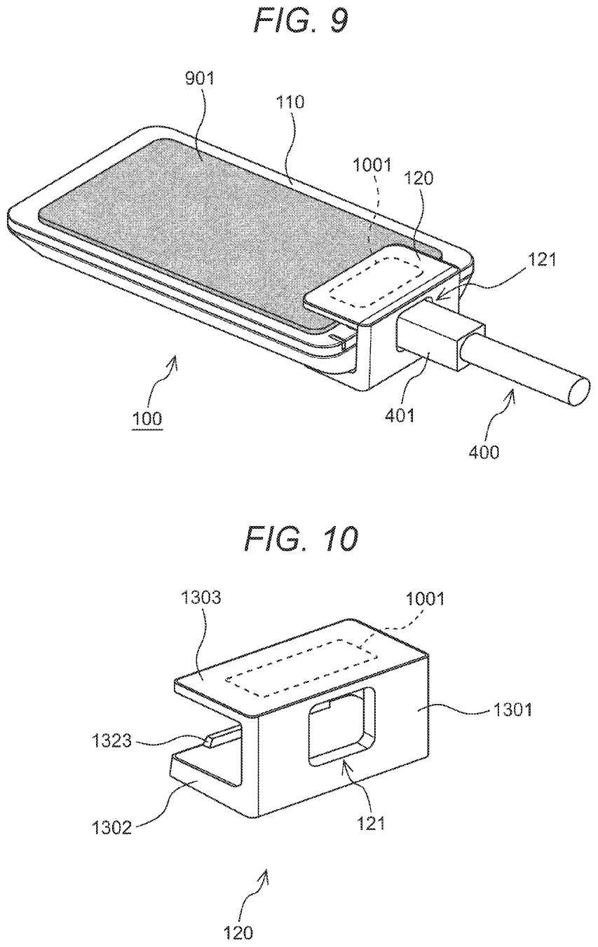

FIG. 9 illustrates a state in which the stand 120 is fitted to the reader/writer main body 110 with an IC card 901 placed on the card reading surface 111. The base side of the reader/writer main body 110 with the IC card 901 placed on the card reading surface 111 is inserted into the opening of the stand 120, the opening having the U shape. In other words, the stand 120 can fix the IC card 901 at a predetermined location on the card reading surface 111 by bundling and clipping the IC card 901 and the reader/writer main body 110.

FIG. 6 illustrates a state an which the stand 120 is fitted to the reader/writer main body 110 on which no IC card is placed (described above). If FIG. 9 is compared with FIG. 6, the opening of the stand 120, the opening having the U shape, expands further outward by the thickness of the IC card 901 placed on the card reading surface 111, and the force of gripping the IC card 901 increases by the restoring force generated at that time, so that the IC card can be firmly fixed on the card reading surface 111 of the reader/writer main body 110.

The stand 120 can be manufactured by a method such as cast molding using an elastic body such as urethane rubber or elastomer. In addition, it is only required to select the hardness of the urethane rubber such that an appropriate gripping force acts when the reader/writer main body 110 with the IC card 901 placed on the card reading surface 111 is inserted into the opening having the U shape and the reader/writer main body 110 is removed moderately easily. For example, the Shore D hardness of 60 is sufficient.

C-2. Structure of Stand

As described above, the stand 120 has a substantially U shape, and is fitted to the reader/writer main body 110 such that the base side of the reader/writer main body 110 is sandwiched inside the U shape. In this section, the structure of the stand 120 will be described in detail.

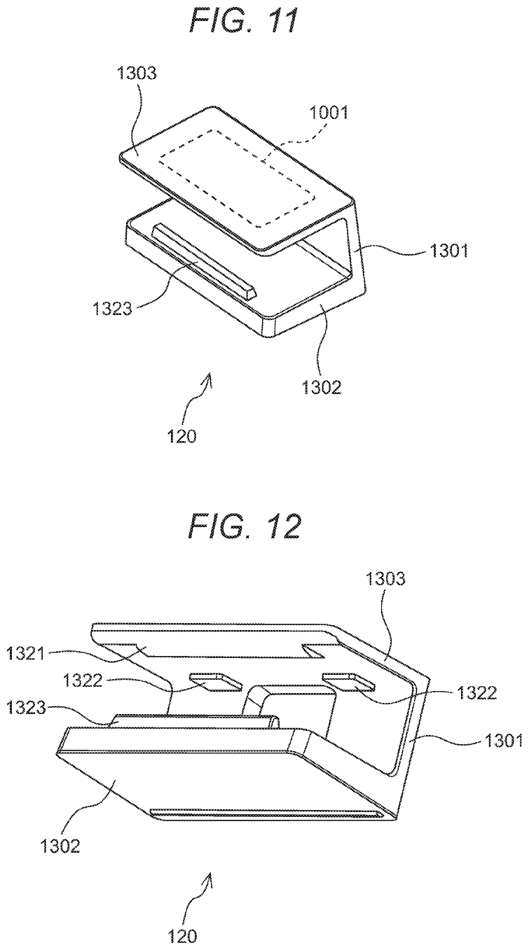

FIGS. 10 to 12 illustrate states in which the stand 120 is viewed from various angles. Furthermore, FIG. 13 illustrates a cross section of the stand 120. As can be seen with reference to FIG. 9, the stand 120 is used in a state where the U shape is rotated 90 degrees on a horizontal setting surface. Hereinafter, a detailed structure of the stand 120 will be described mainly with reference to FIG. 13. It is noted that in FIGS. 10 to 12, the same sections as those illustrated in FIG. 13 are denoted by the same reference signs. For convenience of description, a wall surface of the stand 120 corresponding to the back of the U shape will be referred to as a side wall portion 1301, and of a pair of planar side surfaces connected to upper and lower ends of the side wall portion 1301, the lower one will be referred to as a bottom plate portion 1302, and the upper one will be referred to as a top plate portion 1303.

The stand 120 is manufactured by using an elastic body such as urethane rubber (as described above). The side wall portion 1301, the bottom plate portion 1302, and the top plate portion 1303 are integrally molded by a method such as cast molding.

The bottom plate portion 1302 is a main structural body on which the reader/writer device 100 is placed when the reader/writer device 100 is placed on a setting surface (not illustrated in FIGS. 10 to 13) of a desk or the like. When the reader/writer device 100 is placed on the setting surface, most of the weight is borne by the bottom plate portion 1302. In order to maintain the shape of the stand 120, the bottom plate portion 1302 is formed to be thicker than other sections such as the side wall portion 1301 and the top plate portion 1303.

The top plate portion 1303 is a cantilever having one end fixed to the side wall portion 1301 and the other end being a free end. Therefore, for example, the opening having the U shape can be expanded by pushing up the front end of the top plate portion 1303 in the direction of the arrow denoted by reference sign 1311 in FIG. 13. Then, the stand 120 can be easily fitted by inserting the reader/writer main body 110 which has increased in thickness by placing the IC card 901 on the card reading surface 111 into the opening having the U shape from the base side. Thereafter, if the force of pushing up the front end of the top plate portion 1303 is released, the restoring force of the top plate portion 1303 acts in the direction of the arrow denoted by reference sign 1312, and an appropriate gripping force of gripping the IC card 901 and the reader/writer main body 110 is obtained.

Note that referring to FIG. 13, the bottom plate portion 1302 is in contact with the side wall portion 1301 at a substantially right angle; however, the top plate portion 1303 is inclined by about 5 degrees with respect to a plane orthogonal to the side wall portion 1301 (horizontal plane in a case where the setting surface on which the stand 120 is set is horizontal). Therefore, as described above, the reader/writer main body 110 on which the IC card 901 is placed can be inserted into the opening of the stand 120, the opening having the U shape, by pressing the top plate portion 1303 in the arrow direction indicated by reference sign 1311 in FIG. 13 and deforming the top plate portion 1303 so that the inclination of the top plate portion 1303 becomes smaller than 5 degrees, and the IC card 901 can be held on the reader/writer main body 110 by the restoring force acting in the direction indicated by the arrow 1312. Since the stand 120 includes an elastic body such as urethane rubber or elastomer, the stand 120 has repeated durability even when the stand 120 is deformed many times in directions indicated by the arrows 1311 and 1312.

An opening 121 is formed in the side wall portion 1301. In contrast, the USB connector insertion port 305 is provided on the base side of the reader/writer main body 110. Then, as illustrated in FIGS. 6 and 9, the USB connector 401 can be inserted into the USB connector insertion port 305 provided on the base side of the reader/writer main body 110 through the opening 121 of the stand 120.

A more detailed structure of the stand 120 will be described.

For example, referring to FIGS. 12 and 13, a card holding portion 1321 protruding to the inside of the U shape is provided on the front end side of the lower surface of the top plate portion 1303. The distance to the upper surface of the bottom plate portion 1302 is shortened by the height of the protrusion of the card holding portion 1321, and the gripping force for gripping the IC card 901 and the reader/writer main body 110 is increased correspondingly. Therefore, by providing the protruding portion 1321, the stand 120 can more firmly hold the IC card 901.

Furthermore, for example, referring to FIGS. 12 and 13, a card locking portion 1322 including a pair of right and left protrusions is provided on the back side of the lower surface of the top plate portion 1303. If the IC card 901 is inserted between the upper surface of the reader/writer main body 110 and the top plate portion 1303 of the stand 120, the leading edge of the IC card 901 comes into contact with the card locking portion 1322, and the IC card 901 can be stopped so as not to enter further into the back. The location where the leading edge of the IC card 901 abuts on the card locking portion 1322 is set so as to overlap with an appropriate card reading location. Therefore, by providing the card locking portion 1322 on the top plate portion 1303, a good communication state between the reader/writer main body 110 and the IC card 901 can be maintained.

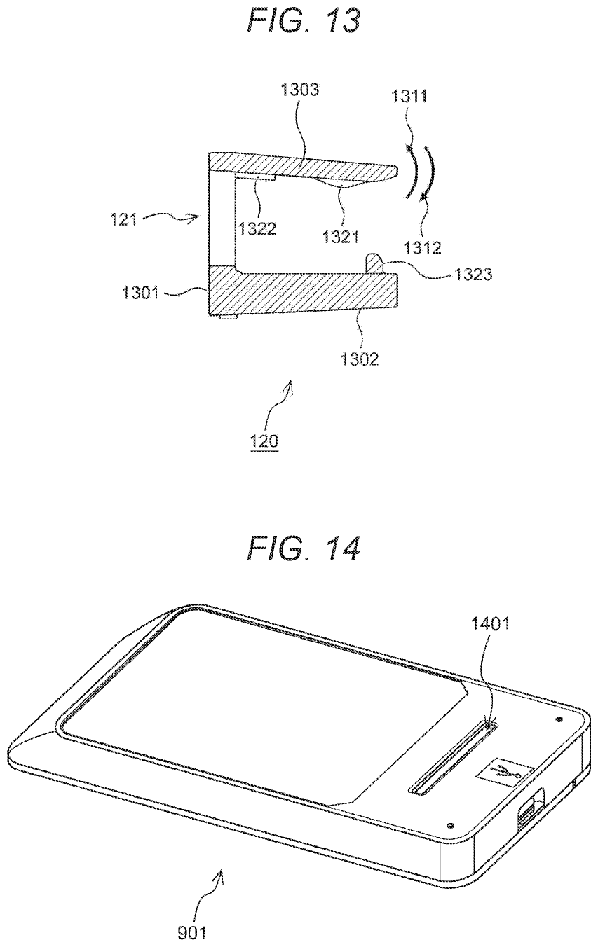

Furthermore, referring to FIGS. 10 to 13, a reader/writer main body fixing portion 1323 including a linear protrusion is provided near the front end of the bottom plate portion 1302. In contrast, FIG. 14 illustrates the bottom surface of the reader/writer main body 110, and a linear groove portion 1401 is formed on the base side of the bottom surface. If the stand 120 is fitted to the base side of the reader/writer main body 110, the reader/writer main body fixing portion 1323 near the front end of the bottom plate portion 1302 is engaged with the groove 1401 on the IC card 901 side, so that the reader/writer main body 110 can be fixed so as not to be easily detached from the stand 120. FIG. 8 illustrates a cross section in a state where the stand 120 is fitted to the reader/writer main body 110 (described above), and it can be confirmed that the reader/writer main body fixing portion 1323 of the bottom plate portion 1302 is engaged with the groove 1401 on the IC card 901 side.

Furthermore, for example, referring to FIG. 10, an area indicated by reference sign 1001 on the upper surface of the top plate portion 1303 may be utilized as an information display area. In the information display area 1001, for example, a logo mark of a manufacturer of the product, a product name, a usage, or the like may be displayed. The method of displaying information in the information display area 1001 is arbitrary. For example, a method of marking the logo mark of the manufacturer, the product name, or the like on a surface at the time of molding, a method of attaching a sticker on which information is printed, a method of arranging a thin display device in the area 1001, or the like may be used.

C-3. Function of Supporting IC Card

The stand 120 has a function of supporting the reader/writer main body 110 in a predetermined posture when the reader/writer device 100 is set on a work surface of a desk or the like.

The reader/writer device 100 is assumed to be put on various objects such as a desk, a table, and a work table and is used. In a case where the reader/writer device 100 is placed on a metal desk and used, there is a concern that an eddy current is generated in the metal by the magnetic field emitted from the reader/writer main body 110 and adversely affects communication between the reader/writer main body 110 and the IC card 901. In contrast, in the case of the reader/writer device 100 according to the present disclosure, the stand 120 is configured to support the reader/writer main body 110 in a posture separated from the setting surface. Therefore, since there is a gap between the reader/writer 110 main body and the setting surface, even if the setting surface includes metal, generation of an eddy current can be prevented by the gap, and the communication state between the reader/writer main body 110 and the IC card 901 can be excellently maintained.

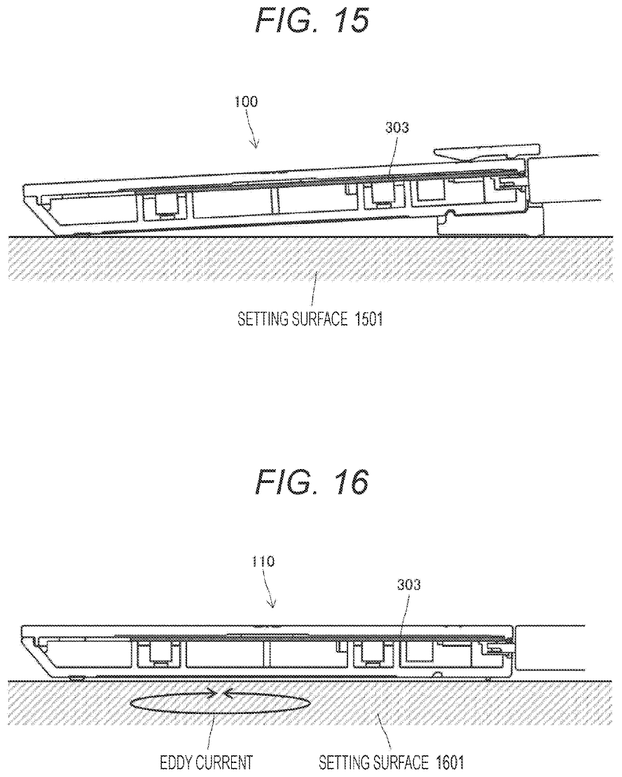

FIG. 15 illustrates a state in which the reader/writer device 100 (that is, the reader/writer main body 110 with the stand 120 fitted to the reader/writer main body 110) is put on a horizontal setting surface 1501. In a state where the stand 120 is fitted to the base side, the reader/writer main body 110 is maintained in a posture inclined by about 3 degrees with respect to the horizontal setting surface. A gap is generated between the bottom surface of the reader/writer main body 110 and the setting surface 1501, and the distance between the substrate 303 on which the loop antenna is mounted and the setting surface is increased by the gap. As a result, an eddy current is prevented from being generated in the setting surface 1501 including metal by the magnetic emitted from the loop antenna, and the communication state between the reader/writer main body 110 and the IC card can be favorably maintained.

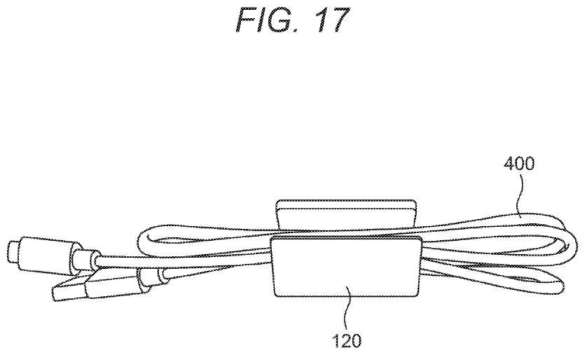

In contrast, as a comparison with FIG. 15, FIG. 16 illustrates a state in which the reader/writer main body 110 to which the stand 120 is not fitted is directly put on a horizontal setting surface 1601. In this case, there is no gap between the bottom surface of the reader/writer main body 110 and the setting surface 1601 including metal, and the distance between the substrate 303 on which the loop antenna is mounted and the setting surface 1601 is shorter by about 2 mm than that in a case where the reader/writer main body 110 takes an inclined posture by using the stand 120. Therefore, an eddy current is generated in the setting surface 1601 including metal by the magnetic field emitted from the loop antenna, and there is a possibility that the communication state between the reader/writer main body 110 and the IC card is adversely affected.

C-4. Structure of Mounting Cable

In the case of a reader/writer device externally connected to an information terminal such as a PC by using a USB cable, if the USB cable is routed in various directions, an external force such as a tensile force is assumed to be applied to the reader/writer device in various directions.

In the case of the present disclosure, as described above, a structure is adopted in which one end of the USB cable 400 is inserted into the base side of the reader/writer main body 110 through the opening 121 of the stand 120, and the direction in which the USB cable 400 comes out from the base side of the reader/writer device 100 is determined (See, for example, FIGS. 9 and 15). Even if external force in various directions acts on the reader/writer main body 110 from the USB cable 400, the reader/writer main body 110 is pulled by the USB cable 400 together with the stand 120 and there is no concern that the reader/writer main body 110 falls off from the stand 120. Furthermore, the stand 120 can fix the IC card 901 at an appropriate location on the card reading surface of the reader/writer device 100, and a good communication state can be maintained.

In addition, as can be seen from FIG. 9, since the USB connector 401 is inserted into the USB connector insertion port 305 provided on the base side of the reader/writer main body 110 through the opening 121 of the stand 120, the USB connector 401 can be attached and removed with the stand 120 mounted on the reader/writer main body 110.

C-5. Function of Storing Cable

In each drawing, only the vicinity of the USB connector 401 to be inserted into the reader/writer main body 110 is illustrated as the USB cable 400 connecting the reader/writer main body 110 and the information terminal (not illustrated), but actually, the cable length is about 1 meter, which is a difficult-to-handle length when not in use, and it is inconvenient to carry the USB cable 400 alone.

As a method of storing a long cable, a method of fixing a bundled cable by using a binding tool such as a clip or a hook and loop fastener is known. However, if the binding tool is used, the number of parts increases.

In contrast, in the present disclosure, the stand 120 may be used to store the bundled USB cable 400. As can be seen from FIG. 13 and the like, the stand 120 has a structure including the opening having the U shape, and a space between the top plate portion 1303 and the bottom plate portion 1302 can be used as a storage place of the bundled USB cable 400.

When the reader/writer device 100 is in use, the stand 120 is fitted to the base side of the reader/writer main body 110; however, when not in use, the stand 120 is removed from the reader/writer main body 110. As described above, since the stand 120 having the U shape is manufactured by using an elastic body such as urethane rubber or elastomer, an object inserted into the opening having the U shape can be gripped with an appropriate force. Therefore, as illustrated in FIG. 17, the bundled USS cable 400 can be inserted and stored in an empty space inside the U-shape formed when the stand 120 is removed from the reader/writer main body 110.

For example, as already described with reference to FIG. 13, the bundled USB cable 400 can be mounted to the stand 120 by pushing up the front eon of the top plate portion 1303 in the direction of the arrow denoted by reference sign 1311 and expanding the opening of the stand 120, the opening having the U shape. Thereafter, if the force of pushing up the front end of the top plate portion 1303 is released, the restoring force of the top plate portion 1303 acts in the direction of the arrow denoted by reference sign 1312, and the stand 120 can hold the bundled USB cable 400.

As already described with reference to FIG. 13, the top plate portion 1303 is inclined by about 5 degrees with respect to the plane orthogonal to the side wall portion 1301 (horizontal plane in a case where the setting surface on which the stand 120 is set is horizontal). Therefore, as described above, the bundled USB cable 400 can be inserted into the opening of the stand 120, the opening having the U shape, by pressing the top plate portion 1303 in the arrow direction indicated by reference sign 1311 FIG. 13 and deforming the top plate portion 1303 so that the inclination of the top plate portion 1303 becomes smaller than 5 degrees, and the bundled USB cable 400 can be held so as not to move by the restoring force acting in the direction indicated by the arrow 1312. Since the stand 120 includes an elastic body such as urethane rubber or elastomer, the stand 120 has repeated durability even when the stand 120 is deformed many times in directions indicated by the arrows 1311 and 1312.

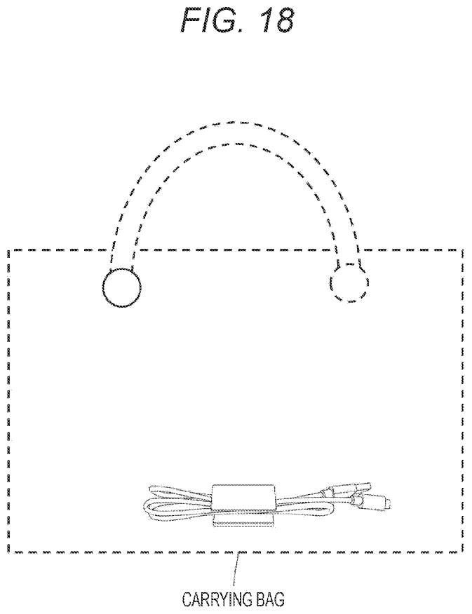

In the storage state of the USB cable 400 as illustrated in FIG. 17, the stand 120 can be put in a carrying bag (see FIG. 18). Since the stand 120 has an appropriate gripping force, the USB cable 400 does not easily come off from the stand 120 due to vibration or the like during movement, and there is no concern that the USB cable 400 is entangled in the bag.

D. Internal Configuration of Reader/Writer Main Body

The reader/writer main body 110 can perform short-range wireless communication with the IC card 901 by using a magnetic field generated when a current flows through the loop antenna.

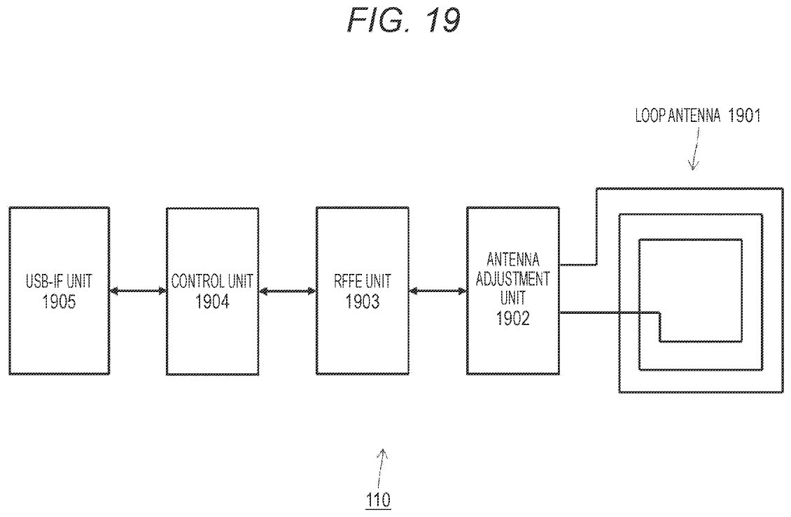

FIG. 19 schematically illustrates an internal configuration example of the reader/writer main body 110. The reader/writer main body 110 includes a communication device that performs short-range wireless communication or non-contact communication based on magnetic coupling with an IC card (not illustrated in FIG. 19) set on the card reading surface 111. The communication device includes a loop antenna 1901, an antenna adjustment unit 1902, an RF analog front end (RFFE) unit 1903, a control unit 1904, and a USB interface (IF) unit 1905.

Each of the loop antenna 1901, the antenna adjustment unit 1902, the RF analog front end (RFFE unit 1903, the control unit 1904, and the USB interface unit 1905 includes circuit components mounted on the substrate 303 (not illustrated in FIG. 19).

The loop antenna 1901 includes, for example, a metal pattern or the like on a loop formed on the substrate 103. The antenna adjustment unit 1902 adjusts the impedance of the loop antenna 1901 so that the loop antenna 1901 and the antenna on the IC card side resonate at a predetermined carrier frequency (for example, 13.56 MHz) to realize non-contact communication by magnetic coupling.

The RF analog front end control unit 1903 transmits a transmission signal to the antenna adjustment unit 1902 on the basis of a transmission request from the control unit 1904, receives and demodulates a reception signal supplied via the antenna adjustment unit 1902, and passes the reception signal that has been demodulated to the control unit 1904.

The control unit 1904 integrally controls the entire operation of the reader/writer main body 110. Specifically, the control unit 1904 instructs the RF front end control unit 1903 to transmit data by non-contact communication on the basis of a request from an information terminal (not illustrated) such as a PC connected via USB via the USB interface unit 1905. Furthermore, the control unit 1904 performs processing for transmitting the reception data received and demodulated by the PE front end control unit 1903 to the information terminal via the USB interface unit 1905. Furthermore, the control unit 1904 performs processing for displaying the operation state (for example, the communication state with the IC card) of the reader/writer main body 110 on the state display unit 112 including an LED or the like.

The USB interface unit 1905 realizes an interface between the reader/writer main body 110 (or the control unit 1904) and USB. Furthermore, the USB interface unit 1905 includes a USB connector such as a USB Micro-B connector or a USB Mini-B connector.

E. Effects

Finally, effects brought by the present disclosure will be summarized.

A reader/writer device to which the present disclosure is applied includes a reader/writer main body that performs non-contact communication with an IC card, and a stand fitted to the reader/writer main body. The stand has a support function of supporting the reader/writer main body in a posture (for example, a posture inclined by approximately 3 degrees with respect to a setting surface) separated from the setting surface, and a card fixing function of fixing the IC card placed on the card reading surface of the reader/writer main body so that the IC card does not come off or fall from the card reading surface. The former support function prevents generation of eddy current in the setting surface including metal, and enables a good communication state to be maintained. Furthermore, since the stand alone has a plurality of functions, that is, the support function and the card fixing function, it is possible to realize a sense of unity in design as compared with the case of using two accessory parts, that is, a card holder and a stand.

According to the present disclosure, it is possible to attach and remove a connection cable such as a USB cable to and from the reader/writer main body with the stand fitted to the reader/writer main body. Furthermore, the reader/writer device configured by fitting the stand to the reader/writer main body is compact and easy to handle.

Since the stand used in the present disclosure includes a material softer than metal, such as urethane rubber or elastomer, the reader/writer main body can be mounted to the stand by single operation, and durability is improved even if the operation of mounting and detaching the reader/writer main body to and from the stand is repeated. Furthermore, since the stand is an elastic body, the stand has an anti-slip cushion function. In addition, when the stand is not in use (in other words, when the stand is not fitted to the reader/writer main body), the bundled USB cable can be sandwiched by the opening of the stand and stored.

Since the stand used in the present disclosure is a structural body including the opening having the U shape and the top plate portion is inclined by about 5 degrees, the reader/writer main body on which the IC card is placed can be held by pushing up the top plate portion. The stand has repeated durability, and the stand can easily store the bundled USB cable.

Furthermore, in the stand used in the present disclosure, the top plate portion can have a function of strengthening the force of holding the IC card and a function of locking the IC card at an appropriate location. Moreover, the stand can have a function of fixing the reader/writer main body to the stand.

### INDUSTRIAL APPLICABILITY

The present disclosure has been described in detail above with reference to a specific embodiment. However, it is obvious that those skilled in the art can make modifications and substitutions of the embodiment without departing from the gist of the present disclosure.

In the present Description, the embodiment in which the present disclosure is applied to the stand that supports the reader/writer main body has been mainly described; however, the gist of the present disclosure is not limited thereto. For example, the present disclosure can be similarly applied to a stand that supports housings of various devices externally attached to an information terminal such as a PC by using a general-purpose cable such as a USB cable.

In short, the present disclosure has been described in the form of exemplification, and the contents described in the present Description should not be interpreted in a limited manner. In order to determine the gist of the present disclosure, the claims should be taken into consideration.

Note that the present disclosure can also be configured as follows.
(1) A reader/writer device including:
a reader/writer main body that communicates with an IC card placed on a card reading surface; and
a stand that supports the reader/writer main body in a posture separated from a setting surface and holds the IC card on the card reading surface.
(2) The reader/writer device according to the (1),
in which the stand has a structure having a substantially U shape and bundles and holds the IC card placed on the card reading surface and the reader/writer main body.
(3) The reader/writer device according to the (1) or (2),
in which the stand includes a side wall portion on a back side of the U shape, a bottom plate portion connected to a lower end of the side wall portion, and a top plate portion connected to an upper end of the side wall portion, and
the side wall portion has an opening through which a cable for connecting the reader/writer main body to an external device is inserted.
(4) The reader/writer device according to the (3),
in which the top plate portion includes a card holding portion that protrudes inside the U shape and abuts on an upper surface of the IC card placed on the reader/writer main body.
(5) The reader/writer device according to the (4),
in which the top plate portion includes a card locking portion that locks a leading edge of the IC card and positions the IC card on the card reading surface.
(6) The reader/writer device according to any one of the (3) to (5),
in which the bottom plate portion includes a fixing portion that fixes the reader/writer main body.
(7) The reader/writer device according to the (6),
in which the fixing portion includes a linear protrusion that is engaged with a linear groove formed in a bottom surface of the reader/writer main body.
(8) The reader/writer device according to any one of the (3) to (7),
in which the bottom plate portion is in contact with the side wall portion at a substantially right angle, and
the top plate portion is inclined by a predetermined angle with respect to a plane orthogonal to the side wall portion (or a horizontal plane is a case where a setting surface on which the stand is set is horizontal).
(9) The reader/writer device according to any one of the (3) to (8),
in which as information display area is provided on an upper surface of the top plate portion.
(10) The reader/writer device according to any one of the (2) to (9),
in which the stand includes urethane rubber, elastomer, or another elastic material.
(11) The reader/writer device according to any one of the (1) to (10),
in which the stand supports the reader/writer main body in a posture inclined by a predetermined angle with respect to a horizontal setting surface.
(12) The reader/writer device according to any one of the (1) to (11),
in which the stand supports the reader/writer main body at a location where a cable for connection to an external device is inserted,
(13) The reader/writer device according to any one of the (1) to (12),
in which the stand stores a cable for connecting the reader/writer main body to an external device.
(14) The reader/writer device according to the (13),
in which the stand has a structure having a substantially U shape and stores the cable which is bundled in an opening that has the U shape.
(15) The reader/writer device according to any one of the (1) to (14),
in which the reader/writer main body includes a display unit in a place that is not hidden by the stand.
(16) The reader/writer device according to the (15),
in which the display unit displays a state of the reader/writer main body.
20 (17) The reader/writer device according to any one of the (1) to (16),
in which the reader/writer main body includes an antenna, an antenna adjustment unit that adjusts impedance of the antenna, an RF front end unit that processes a transmission/reception signal of the antenna, a control unit that controls processing in the RF front end unit, and an interface unit that is connected to an external device.
(18) A stand for a reader/writer including:
a support portion that supports a reader/writer main body in a posture separated from a setting surface; and
a holding portion that holds an IC card placed on a card reading surface of the reader/writer main body.
(19) The stand for the reader/writer according to the (18),
in which the stand has a structure having a substantially U shape and bundles and holds the IC card placed on the card reading surface and the reader/writer main body.
(20) The stand for the reader/writer according to the (18) or (19),
in which the stand includes a side wall portion on a back side of the U shape, a bottom plate portion connected to a lower end of the side wall portion, and a top plate portion connected to an upper end of the side wall portion, and
the side wall portion has an opening through which a cable for connecting the reader/writer main body to an external device is inserted.
(21) The stand for the reader/writer according to the (20),
in which the top plate portion includes a card holding portion that protrudes inside the U shape and abuts on an upper surface of the IC card placed on the reader/writer main body.
(22) The stand for the reader/writer according to the (21),
in which the top plate portion includes a card locking portion that locks a leading edge of the IC card and positions the IC card on the card reading surface.
(23) The stand for the reader/writer according to any one of the (20) to (22),
in which the bottom plate portion includes a fixing portion that fixes the reader/writer main body.
(24) The stand for the reader/writer according to the (23),
in which the fixing portion includes a linear protrusion that is engaged with a linear groove formed in a bottom surface of the reader/writer main body.
(25) The stand for the reader/writer according to any one of the (20) to (24),
in which the bottom plate portion is in contact with the side wall portion at a substantially right angle, and
the top plate portion is inclined by a predetermined angle with respect to a plane orthogonal to the side wall portion (or a horizontal plane in a case where a setting surface on which the stand is set is horizontal).
(26) The stand for the reader/writer according to any one of the (20) to (25),
in which an information display area is provided on an upper surface of the top plate portion.
(27) The stand for the reader/writer according to any one of the (20) to (26),
in which the stand includes urethane rubber, elastomer, or another elastic material.
(28) The stand for the reader/writer according to any one of the (18) to (27),
in which the reader/writer main body is supported in a posture inclined by a predetermined angle with respect to a horizontal setting surface.
(29) The stand for the reader/write=according to any one of the (18) to (28),
in which the reader/writer main body is supported at a location where a cable for connection to an external device is inserted.
(30) The stand for the reader/writer according to any one of the (18) to (29),
in which a cable for connecting the reader/writer main body to as external device is stored when the stand is not fitted to the reader/writer main body.
(31) The stand for the reader/writer according to the (30),
in which the stand has a structure having a substantially U shape and the cable which is bundled is stored in an opening that has the substantially U shape.

### REFERENCE SIGNS LIST

100 Reader/writer device
110 Reader/writer main body
111 Card reading surface
120 Stand
121 Opening
301 Upper casing
302 Lower casing
303 Substrate
304 Cutout portion
305 Opening portion (USB connector insertion port)
400 USB cable
401 USB connector
901 IC card
1001 Information display area
1301 Side wall portion
1302 Bottom plate portion
1303 Top plate portion
1321 Card holding portion
1322 Card locking portion
1323 Reader/writer main body fixing portion
1401 Groove
1901 Loop antenna
1902 Antenna adjustment unit
1903 RF front end unit
1904 Control unit
1905 USB interface unit

1. A reader/writer device comprising:
a reader/writer main body that communicates with an IC card placed on a card reading surface; and
a stand that supports the reader/writer main body in a posture separated from a setting surface and holds the IC card on the card reading surface.

2. The reader/writer device according to claim 1,
wherein the stand has a structure having a substantially U shape and bundles and holds the IC card placed on the card reading surface and the reader/writer main body.

3. The reader/writer device according to claim 1,
wherein the stand includes a side wall portion on a back side of the U shape, a bottom plate portion connected to a lower end of the side wall portion, and a top plate portion connected to an upper end of the side wall portion, and
the side wall portion has an opening through which a cable for connecting the reader/writer main body to an external device is inserted.

4. The reader/writer device according to claim 3,
wherein the top plate portion includes a card holding portion that protrudes inside the U shape and abuts on an upper surface of the IC card placed on the reader/writer main body.

5. The reader/writer device according to claim 4,
wherein the top plate portion includes a card locking portion that locks a leading edge of the IC card and positions the IC card on the card reading surface.

6. The reader/writer device according to claim 3,
wherein the bottom plate portion includes a fixing portion that fixes the reader/writer main body.

7. The reader/writer device according to claim 6,
wherein the fixing portion includes a linear protrusion that is engaged with a linear groove formed in a bottom surface of the reader/writer main body.

8. The reader/writer device according to claim 3,
wherein the bottom plate portion is in contact with the side wall portion at a substantially right angle, and
the top plate portion is inclined by a predetermined angle with respect to a plane orthogonal to the side wall portion.

9. The reader/writer device according to claim 3,
wherein an information display area is provided on an upper surface of the top plate portion.

10. The reader/writer device according to claim 2,
wherein the stand includes urethane rubber, elastomer, or another elastic material.

11. The reader/writer device according to claim 1,
wherein the stand supports the reader/writer main body in a posture inclined by a predetermined angle with respect to a horizontal setting surface.

12. The reader/writer device according to claim 1,
wherein the stand supports the reader/writer main body at a location where a cable for connection to an external device is inserted.

13. The reader/writer device according to claim 1,
wherein the stand stores a cable for connecting the reader/writer main body to an external device.

14. The reader/writer device according to claim 13,
wherein the stand has a structure having a substantially U shape and stores the cable which is bundled in an opening that has the U shape.

15. The reader/writer device according to claim 1,
wherein the reader/writer main body includes a display unit in a place that is not hidden by the stand.

16. The reader/writer device according to claim 15,
wherein the display unit displays a state of the reader/writer main body.

17. The reader/writer device according to claim 1,
wherein the reader/writer main body includes an antenna, an antenna adjustment unit that adjusts impedance of the antenna, an RF front end unit that processes a transmission/reception signal of the antenna, a control unit that controls processing in the RF front end unit, and an interface unit that is connected to an external device.

18. A stand for a reader/writer comprising:
a support portion that supports a reader/writer main body in a posture separated from a setting surface; and
a holding portion that holds an IC card placed on a card reading surface of the reader/writer main body.

19. The stand for the reader/writer according to claim 18,
wherein the stand has a structure having a substantially U shape and bundles and holds the IC card placed on the card reading surface and the reader/writer main body.

20. The stand for the reader/writer according to claim 18,
wherein the stand includes a side wall portion on a back side of the U shape, a bottom plate portion connected to a lower end of the side wall portion, and a top plate portion connected to an upper end of the side wall portion, and
the side wall portion has an opening through which a cable for connecting the reader/writer main body to an external device is inserted.
